(19) United States
(12) Patent Application Publication
(10) Pub. No.: US 2002/0111954 A1
(43) Pub. Date: Aug. 15, 2002

(54) Software system for convergence and demographic measurement

(76) Inventor: Robert E. McCoy, West Chester, OH (US)

Correspondence Address: Philip M. Weiss, WEISS & WEISS, 500 OLD COUNTRY ROAD, GARDEN CITY, NY, 11530, US

(21) Appl. No.: 10/074,401

(22) Filed: Feb. 12, 2002

Related U.S. Application Data
(60) Provisional application No. 60/268,140, filed on Feb. 12, 2001.

(51) Int. Cl. G06F 7/00

(52) U.S. Cl. 707/104.1

(57) ABSTRACT

A system and method for forecasting and measuring traffic between non-Internet advertising and the Internet.

### FIELD OF THE INVENTION

The present invention relates to a system and method for forecasting and measuring traffic between non-Internet advertising and the Internet.

### BACKGROUND OF THE INVENTION

In radio and television, the question of “how many” listeners and viewers has become an industry to companies such as ARBITRON and NEILSON Rating Services. This “middleman” became necessary to provide impartial third party opinion of the audience size to allow paying advertisers a tool for the expenditure of their advertising dollars. The third party opinion is not a measured quantity, but rather a statistical estimate based on paper ballot and telephone polling data. Similar systems are in place for newspapers and magazines. The Internet provides a means to measure a result based on an event.

### SUMMARY OF THE INVENTION

The present invention relates to a system for determining which advertisements direct a user to click on which web site. The system comprises a database comprising information about a user's media buys. The system further comprises a second database comprising a user's IP addresses. The system compares information from the first database with information from the second database to determine which of a user's advertisements generated the web clicks.

The system further comprises generating a report which shows which of the advertisements generated the web clicks. The information about a user's media buys can include; date and time of advertising; type of advertising; location of advertisement and an expiration date for the advertisement. The information about a user's media buy can also include the cost of the advertisement. The information about a user's media buy can also include the demographics of the advertisement. The system of the present invention can generate a report which shows which of the web clicks do not correspond to any advertisement.

The present invention relates to a method for determining which advertisements direct which web clicks comprising; inputting information about a user's media buys into a database; inputting information about a user's IP addresses into a second database; and comparing information from the first database with information from the second database to determine which of the advertisements generated the web clicks. The method can further include generating a report which shows which of the advertisements generated the web clicks. The method can further include determining the cost efficiency of the advertisement, meaning the cost of the advertisement versus how much was spent on the advertisement.

The present invention provides a software tool, which measures the rate of convergence. The present invention relates to a system that estimates the likelihood of a specific timed event, a clocked web site visit or hit, and the previous most recent media advertisement known to the program. It is an object of the present invention to quantify the impact of an element of a broadcast or advertisement. It is an object of the present invention to provide qualified information to advertisers. It is an object of the present invention to provide information for the development of new programming to meet advertiser's needs. It is an object of the present invention to give marketing professionals a tool for the placement of marketing dollars.

The technology exists on the Internet to track the intimate details of “click through” audience behavior. But this industry only measures its own media type. The present invention correlates the activities of an outside media event to the measured activity of an Internet site. In effect building a comprehensive database of understanding for cause and effect. It is an object of the present invention to take this comprehensive database to then forecast how certain non-Internet media will drive traffic to the Internet.

It is an object of the present invention to allow companies to scientifically invest marketing monies with a greater understanding of the outcome. It is an object of the present invention to provide a system that allows advertisers to work closely with external media to produce programming and advertising that draws a specific audience to receive the message thus maximizing niche market possibilities.

It is an object of the present invention to determine what type of advertising in what geographic location produced the most amount of hits on a web site for the least amount of advertising spending.

### BRIEF DESCRIPTION OF THE DRAWINGS

FIG. 1 is an example of an input screen for an advertisement.

FIG. 2 is a table illustrating an advertisement report

FIG. 3 is an example of an input screen for IP information.

FIG. 4 is a Advertisement Hit Detailed Report

FIG. 5 is a Report showing unaccounted Hits to the Website.

### DETAILED DESCRIPTION OF THE INVENTION

In a preferred embodiment, an Internet company wishes to drive traffic to their Internet site via non-Internet advertising. The Internet company advertises using television, radio and newspaper ads. The Internet company provides the information concerning where these particular ads are being run demographically and the date and time the ads are run to the system of the present invention. The present invention stores this information.

The present invention stores the times of the day that a person logs onto the site along with the location of the person logging onto the site using their IP address. The system then subtracts from the stored Internet information, the Internet traffic that was from links from other sites and not from direct logins to the site. The system of the present invention then compares the timing and location of the advertising to the timing and location of when a user logged on to the Internet site. The system of the present invention then statistically determines which source of advertising caused a user to log on to that Internet site.

With the proper information, the system of the present invention can then predict based on prior sets of advertisements, the amount of traffic an Internet site will get from a particular source of advertisement in a particular location. The more historical data the system has regarding the location and timing of advertisements versus the location and timing of Internet logons, the more accurate the statisitics that are provided by the system of the present invention.

The software database of the present invention contains detailed demographic, geographic and timing information on the types of media used versus the number of times a person has logged into a site. Based on this information, the database of the present invention can generate a recommendation and forecast concerning where and in what form a companies ads should be run demographically, geographically, and when. Based on how the forecast worked, the system can modify their next forecast.

### EXAMPLE

Internet Company A advertises on TV in the New York area on January 1 at 12:00 A.M., on radio in Chicago on January 3 at 3:00 P.M. and 5:00 P.M. and places newspaper ads the week of January, 7 in Florida. The system of the present invention can then determine how many persons logged into the site of Company A from what location and at what time, and determine statistically which of the above advertisements caused the traffic to the web site. This information can then be provided to Company A to assist it in determining which form of advertising is most beneficial in which part of the country to direct traffic to their Internet site.

In an embodiment of the present invention all media data is input into the system of the present invention. The system of the present invention also has access to a companies IP address data from a companies web log. In a preferred embodiment, the database of the present invention creates one or more tables. A standard IP address table includes the IP address, the city, state, date and time that a user clicked onto a web site. The media information can contain information such as date and time that the advertisement was shown, the location of the advertisement including the city and the state, the type of advertisement, such as radio or television, and the expiration of the advertisement. The expiration of an advertisement means when does the user no longer believe that this particular advertisement has caused a user to click onto their web site. The expiration date can be changed. For instance, a user can broadcast an advertisement on SuperBowl Sunday and believe that this may effect a user for a week, and therefore put the expiration date of the advertisement at one week. The user can then change this expiration date to two days, to later determine which of these expiration dates gave a better approximation why a user clicked on their web site.

A report would include the most likely advertisements which caused a user to click onto a web site. In a preferred embodiment, the report should tally the number of bits per media. A second report shows the hits which do not come from any advertisement.

A further report can be added which shows the IP addresses and locations of those persons that clicked in from another web site.

In a preferred embodiment, the system includes a database to collect information of advertising media; an entry screen to provide a means to enter advertising media information into the database; and a means to print a report comparing the database tables.

The present invention allows a user to download media demographic data to allow a company media buyer to:

select media buys based on a demographic query;

have instant access to ad rate data;

input media budget;

auto-generate media buying recommendations based on demographic input;

determine based on demographics the visitors to a web site.

In a preferred embodiment, the system of the present invention has access to the Arbitron and Neilson Market Rating Services.

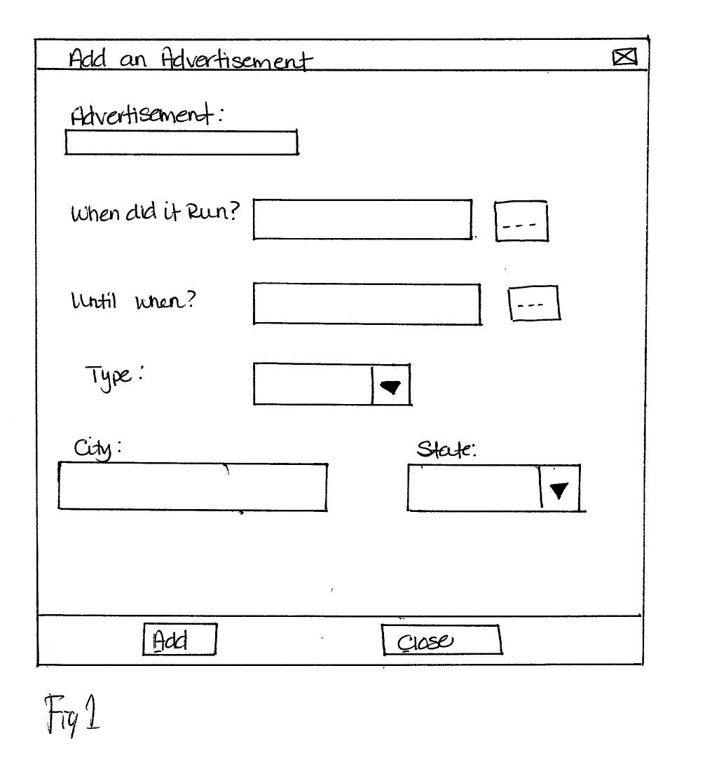

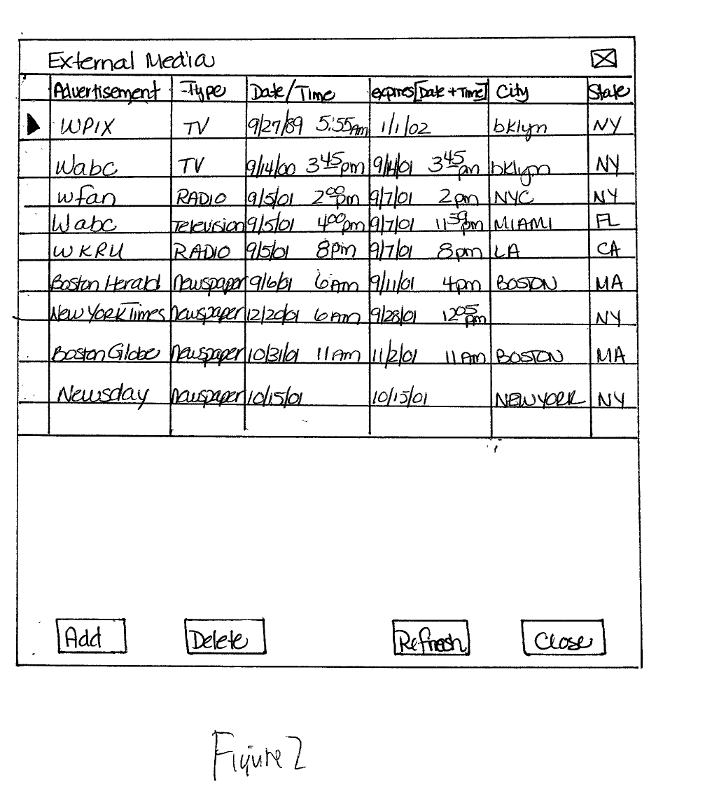

FIG. 1 illustrates an input screen for adding information concerning an advertisement. As shown in FIG. 1 a user types in or otherwise inputs information concerning their advertisement, such as WFAN, Boston Globe, etc. as shown in FIG. 2. The user then inputs when the advertisement ran. A user can either type in the date or choose the date from a calendar feature in the system. The time is also inputted into the database. The WFAN advertisement ran on Sep. 5, 2001 at 2:00 PM. The system also requests information concerning an expiration date, or how long the user believes that the advertisement will attract users to their web site. For the WFAN advertisement, the user believed that the radio advertisement may bring viewers to their web site until Sep. 7, 2001 at 2:00 PM. The user can change the expiration date to determine if other potential web clicks were due to this advertisement at a later date. The user can then type in the city where the advertisement is being advertised and the state. These features can either be typed in or selected from a menu. The type of media can be selected from a menu or typed in. Types of media include: banners, email, radio, television, newspaper, magazine, web site, etc.

Other information that can be added to this screen is the cost of the advertisement. This could provide information to the user regarding which is the most cost effective way to bring users to their web site.

In a further embodiment, the demographics of each particular advertisement can also be inputted. One advertisement can be shown during a television show where the demographics is 20-40 year old males, but the cost for the advertisement is 10 times more than a magazine ad for women 60 and older. It is then a matter of the value of getting the 20-40 year old men to the user's web site. The system of the present invention will provide all of this information to the user.

After the information is inputted into the screen shown in FIG. 1, a table can be generated illustrating this information as shown in FIG. 2. Information can be added and deleted from the table.

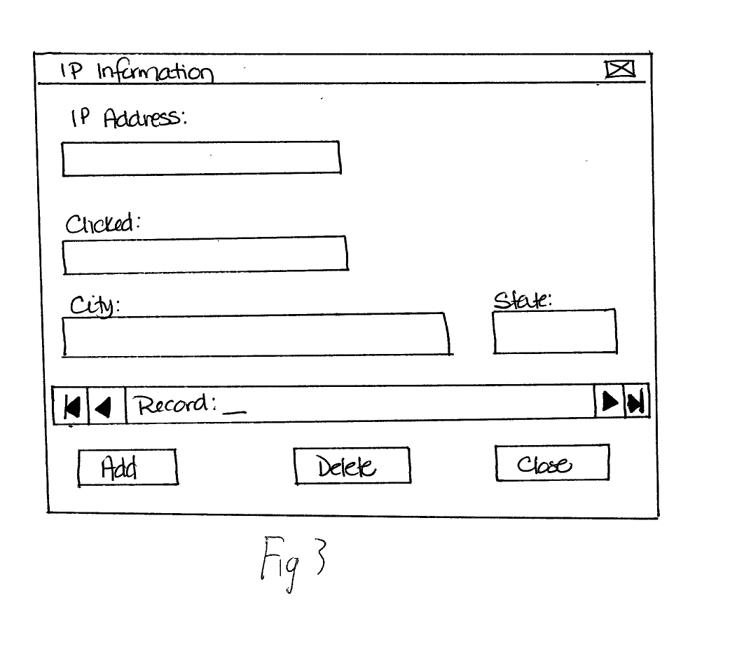

FIG. 3 illustrates a screen for entering information regarding web site click information. A user can input the IP address of a person who logged onto their website, the date and time of the click, and the state and the city where the IP address is located.

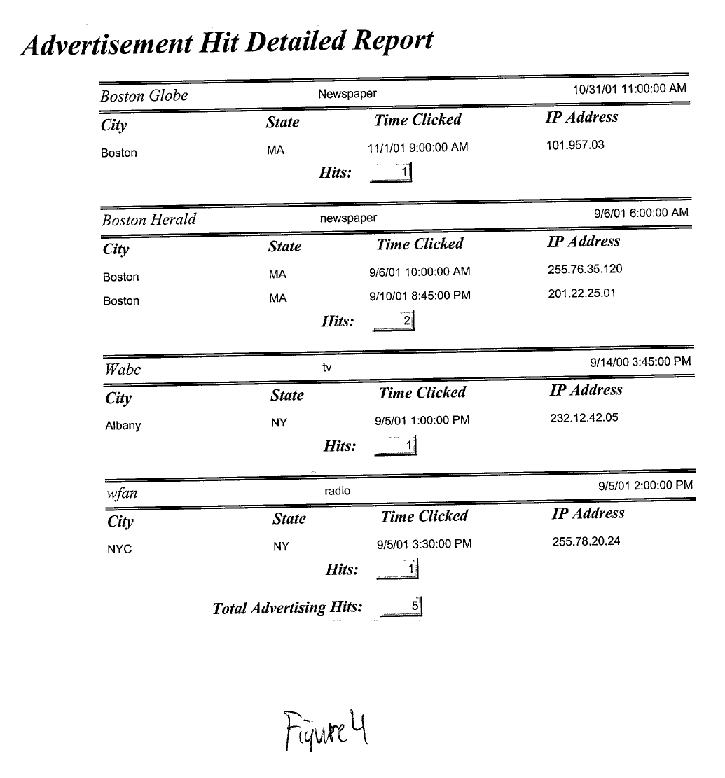

FIG. 4 is an Advertisement Hit Detailed Report. The report shows the location where the advertisement was placed, the type of advertisement, and the date and time the ad was run. The report also shows the IP address, including the city, state and time clicked that matched that advertisement.

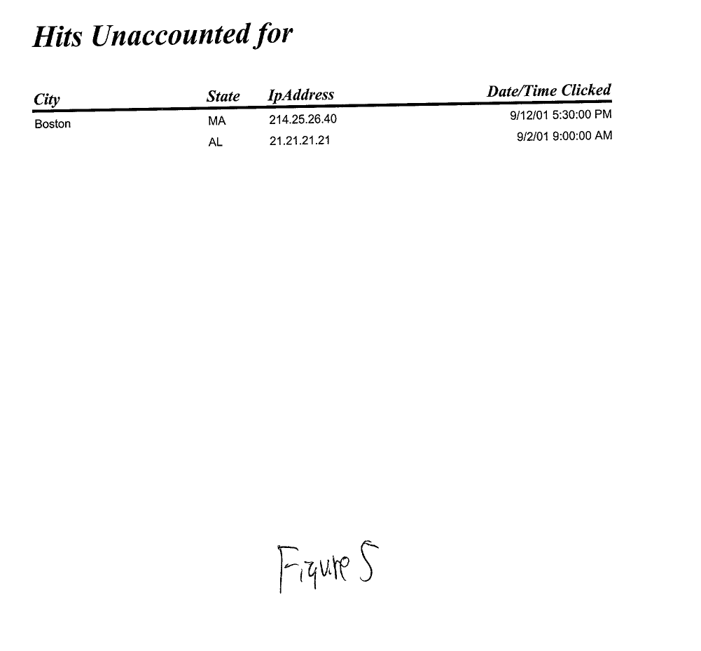

FIG. 5 is a Report showing the unaccounted hits. This lists the city, state, IP Address and date and time that the web site was clicked. Based on the information entered into the system, these are hits on the site that did not correspond to an advertisement.

For example, as shown in FIG. 5 web clicks in Massachusetts and Alabama on those particular times and dates did not match any advertising that was inputted into the system in those locations at those times.

1. A system for determining which advertisements direct which web clicks comprising;
a database comprising information about a user's media buys;
a second database comprising a user's IP addresses;
said system comparing information from said first database with information from said second database to determine which of said advertisements generated said web clicks.

2. The system of claim 1 further comprising;
a report which shows which of said advertisements generated said web clicks.

3. The system of claim 1 wherein said information about a user's media buys comprises;
date and time of advertising; type of advertising; location of advertisement and an expiration date for said advertisement.

4. The system of claim 3 wherein said information about a user's media buys further comprises the cost of said advertisement.

5. The system of claim 3 wherein said information about a user's media buys further comprises the demographics of said advertisement.

6. The system of claim 1 further comprising;
a report which shows which of said web clicks do not correspond to an advertisment.

7. A method for determining which advertisements direct which web clicks comprising;
inputting information about a user's media buys into a database;
inputting information about a user's IP addresses into a second database;
comparing information from said first database with information from said second database;
determining which of said advertisements generated said web clicks.

8. The method of claim 7 further comprising;
generating a report which shows which of said advertisements generated said web clicks.
